(19) United States
(12) Patent Application Publication
(10) Pub. No.: US 2017/0195253 A1
(43) Pub. Date: Jul. 6, 2017

(54) FLEXIBLE PIPELINE ARCHITECTURE FOR MULTI-TABLE FLOW PROCESSING

(71) Applicant: Fortinet, Inc., Sunnyvale, CA (US)

(72) Inventors: Sashidhar V. Annaluru, Cupertino, CA (US); Venkateswara Adusumilli, San Jose, CA (US); Che-Lin Ho, San Jose, CA (US); Shivashakara Desigowda, San Jose, CA (US); Edward Lopez, South Riding, VA (US)

(73) Assignee: Fortinet, Inc., Sunnyvale, CA (US)

(21) Appl. No.: 14/985,746

(22) Filed: Dec. 31, 2015

(51) Int. Cl. H04L 12/947; H04L 12/813; H04L 12/24; H04L 12/745

(52) U.S. Cl. CPC H04L 49/25; H04L 45/748; H04L 47/20; H04L 41/20

(57) ABSTRACT

Methods and systems for implementing scalable SDN devices having a flexible data path pipeline having multiple flow tables and a hybrid memory approach are provided. According to one embodiment, an SDN switch performs a method of storing a flow table within a memory device most suitable for the type of rules contained within the flow table. A flow table for use in connection with determining how to process a packet received by the SDN switch is received by the SDN switch. The flow table is stored within a DRAM device of the SDN switch when rules contained within the flow table include keys against which exact matching is performed with fields of the packet. The flow table is stored within a TCAM device of the SDN switch when rules contained within the flow table include keys against which regular expression-based matching is performed with the fields of the packet.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2015, Fortinet, Inc.

### BACKGROUND

Field

Embodiments of the present invention generally relate to software-defined networking (SDN). In particular, embodiments of the present invention relate to scalable SDN devices having a flexible data path pipeline based on a hybrid memory approach in which Dynamic Random Access Memory (DRAM) and Ternary Content-Addressable Memory (TCAM) resources are logically divided into multiple flow tables.

Description of the Related Art

Global Internet Protocol (IP) traffic has increased fivefold in the last five years, and is expected to increase threefold over the next five years. As the number of mobile devices and other IP devices connecting to the Internet are growing rapidly, data traffic that needs to be monitored and inspected by network security devices is also increasing. Such increasing data traffic from different types of devices is creating new vulnerabilities that need to be monitored/inspected and controlled by the network security devices. As new types of network security issues are emerging, the network security devices need to include new policy rules to monitor and control the data traffic to/from a secured network. It is becoming difficult for hardware-based switches or network security devices to provide the required scalability for rapidly increasing data traffic and increasing policy rules. To overcome the limitations of existing hardware-based switches or network security devices, which lack the flexibility of incorporating new and different forwarding rules, SDN devices that allow updates at regular intervals have been proposed for providing scalable and fast processing of network packets.

With such features, typical SDN devices, e.g., SDN switches, are moving to replace, and are being configured to work in conjunction with traditional routers and switches in several high end applications, including the emerging cloud and datacenter environments where high volumes of traffic need to be monitored and filtered. To facilitate communications among different network devices or SDN devices, the OpenFlow protocols, including, but not limited to Open Networking Foundation (ONF), “OpenFlow Switch Specification,” Version 1.5.0 (Protocol version 0x06), December 19, 2014 (hereafter, the “OpenFlow Protocol”), are now being used. The OpenFlow Protocol is hereby incorporated by reference in its entirety for all purposes.

SDN is an approach to computer networking that allows network administrators to manage network services through abstraction of lower-level functionality. This is done by decoupling the operating system that makes decisions about where the traffic is sent (the control plane) from underlying hardware systems that forward traffic to the selected destinations (the data plane). A typical enterprise network device may have a controlling element, and a forwarding element within the same box that implements the SDN features. The forwarding elements are configured to receive packets, do conversion(s), if required, and forward the packets to their respective destinations based on instructions received from the controlling elements. In implementation, forwarding elements (also referred to as the data plane) receive forwarding commands from the control plane (also referred to as the controller) where the forwarding elements make the forwarding decision to be implemented in the data plane. The control plane is typically a collection of software running within a router or within a switch that uses one or more rule sets to identify the packet(s) received from traffic, decide appropriate actions to be taken on the packet(s), and convey the actions/decisions to the data plane so the data plane knows where to forward the packet(s).

A typical SDN device/switch maintains one or more tables containing multiple rules that may include both regular expression-based rules and exact match-based rules for performing data inspection and/or forwarding. These tables may have some entries that require an exact key match, for example, a match between a source IP address or a destination IP address and the key; and others that require a regular expression-based match, for example, subnet based matching or port range based matching. In a typical SDN implementation, an IP packet may traverse through a variety of different network functions or security checks before the IP packet is forwarded to the final destination. On receiving a data packet, the SDN switch/device searches for appropriate rule(s) in the tables in order to make a forwarding decision and/or determine appropriate actions to perform on the packet based on a matching rule. In most cases, these SDN devices, which may also be referred to interchangeably as SDN switches, use TCAM-based platforms that make use of programmed flow statements to perform packet forwarding decisions, either in lieu of or in concert with forwarding tables generated by traditional routing and switching protocols.

Some existing SDN switches use single-table pipeline architectures in which a table contains multiple fields, each of which represent a different property of a packet that may be checked by the SDN switch in connection with making a forwarding decision. The table includes a long list of policy rules/entries based on these fields, which may be predefined or programmable entries that are used by the SDN switches before making any forwarding decision. Such single-table pipeline architectures typically have excellent forwarding properties when evaluating a small number of fields, e.g., a Media Access Control (MAC) address or an IP address; however, these SDN switches lack scalability, particularly when the number of entries in a table that need to be checked before making a forwarding decision exceed a particular threshold. While single-TCAM switches can have excellent forwarding properties when evaluating a small number of fields in a flow table; if the flow table has a large number of fields/entries, as is the case with the OpenFlow Protocol, which defines a minimum of thirteen fields within a single-table pipeline, the number of supported flow-table entries by OpenFlow-capable SDN switches is reduced dramatically. Meanwhile, increasing the size of the TCAM is not a practical solution due to costs, power consumption and other factors. For example, it may be cost-prohibitive to attempt to include all of the required fields and entries within a single table that is to be stored in a TCAM device. Efforts have been made to minimize the number of fields and entries in a flow table, but such minimization efforts come at the cost of security/performance degradation, and possible security compromise. On the other hand, increasing the size of a single table for a complex packet header search can result in significant performance bottlenecks for an SDN switch.

The OpenFlow Protocol, which is instrumental to the success of SDN devices, was defined to increase flexibility and programmability of networks/network devices for allowing network administrators to more easily tailor network configurations to their needs. The OpenFlow Protocol requires an SDN switch to contain a series of associative flow tables. Each entry in a table may contain ternary values for a desired selection of packet fields, e.g., MAC source and destination addresses, IP source and destination addresses and Transmission Control Protocol (TCP) port numbers. The OpenFlow Protocol defines a number of standardized packet header fields for matching as well as allowing users to add their own custom fields. Table entries are in prioritized order, and for each individual packet processed by an SDN switch, the table entries are searched in order for a matching entry. The table entries can have ternary values to match a broad selection of packets. When the first matching table entry is found, a set of actions associated with that table entry are executed. Such actions may modify fields of the packet, for example, by setting the MAC destination field to a new value, or may direct the SDN switch to output the packet to a particular switch port in a particular queue or drop the packet. It is generally intended that when existing flow tables do not know how to handle a packet, the packet is sent to the SDN controller, which may respond by installing rules within the SDN switch to properly process subsequently received packets having similar characteristics. This accomplishes the goal of control and data plane separation by having the SDN controller software make the decisions concerning what flow tables are to be installed, whereas the SDN switch simply follows the directives of the SDN controller instead of making complex behavioral decisions on its own. In general, existing SDN switches are configured to be able to flexibly match packets, and directed by the matches, perform a comprehensive set of actions to modify the packet and/or decide what to do with the packet. This is done with a number of tables that may operate on the packet sequentially.

In order to overcome the limitation of single table pipeline based SDN devices, which compare received data packet properties with all entries of the table for all the fields in a sequential manner, existing solutions propose the use of multi-table pipelines in which Field Programmable Gate Arrays (FPGAs) plus memory or DRAM can be used to perform high-performance searches of simple tables. However, searching DRAM-based tables is slower as compared to TCAM-based table search. In an attempt to address the size and associated performance limitations as well as provide scalability, SDN switches have been modified to use dedicated hardware. For example, microcode within FPGAs has been used to mimic TCAM and search functions thereof on a limited basis. However, this has forced the use of multi-table based packet processing pipelines, which adds complexity as compared to the simplicity and speed of single-table based packet processing pipelines supported by true TCAMs.

Attempts have been made to minimize the size of these programmable flow tables, however such minimized programmable flow tables risk of performance degradation. As the size of tables and the number of tables are increasing, it is not possible to keep all of the required tables in TCAMs, and hence alternative solutions are required. The least expensive devices (silicon chips) that can be used to implement lookup tables are DRAM-based devices, but they are not efficient. DRAM-based tables also waste a lot of memory when used for regular expression-based searching/matching. The most efficient devices for performing regular expression-based searching/matching are TCAM devices, but they are very expensive and use a lot of power, and hence are used for small tables. Several data-path devices use either a DRAM-based approach or a TCAM-based approach, yielding advantages in one aspect, but limitations in relation to other aspects.

Therefore, there is a need for systems and architectures that provide scalable and high performance SDN devices that use multi-table flexible architectures/configurations that are able to achieve the advantages of both TCAM-based tables and DRAM-based tables.

### SUMMARY

Methods and systems are described for implementing scalable SDN devices having a flexible data path pipeline having multiple flow tables and a hybrid memory approach. According to one embodiment, an SDN switch performs a method of storing a flow table within a memory device most suitable for the type of rules contained within the flow table. A flow table for use in connection with determining how to process a packet received by the SDN switch is received by the SDN switch. The flow table is stored within a Dynamic Random-Access Memory (DRAM) device of the SDN switch when rules contained within the flow table include one or more keys against which exact matching is performed with one or more fields of the packet. The flow table is stored within a Ternary Content-Addressable Memory (TCAM) device of the SDN switch when rules contained within the flow table include one or more keys against which regular expression-based matching is performed with the one or more fields of the packet.

Other features of embodiments of the present disclosure will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary SDN architecture designed in accordance with an embodiment of the present disclosure.

FIG. 2 illustrates another exemplary SDN architecture in accordance with an embodiment of the present disclosure.

FIG. 3 illustrates exemplary configuration and use of flow tables stored in TCAM and DRAM devices for performing flow control functions in accordance with an embodiment of the present invention.

FIG. 4 illustrates an exemplary distribution of a single lookup table into a first table stored in a DRAM device, and a second table stored in a TCAM device in accordance with an embodiment of the present invention.

FIG. 5 illustrates an exemplary flow diagram showing the use of flow tables stored in TCAM and DRAM devices in accordance with an embodiment of the present invention.

### DETAILED DESCRIPTION

Methods and systems are described for implementing scalable SDN devices having a flexible data path pipeline having multiple flow tables and a hybrid memory approach. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present invention generally relate to SDN architectures. In particular, embodiments of the present invention relate to scalable SDN devices having a flexible pipeline architecture for multi-table flow processing.

In an aspect, the present disclosure relates to an SDN switch that can be configured to store a flow table in either a DRAM device or in a TCAM device depending upon the particular table match criteria. For example, the flow table can be stored in a DRAM device when exact match-based rules are implemented by the flow table and the flow table can be stored in a TCAM device when regular expression-based rules are implemented by the flow table.

In an aspect, the switch can form part of a switch cluster that can be operatively coupled with an SDN controller, wherein the SDN controller can be configured to update rules in the flow table to control rules that are set up for each packet flow.

In an aspect, the flow table stored in the DRAM device can be configured to enable processing of packets that require exact match type based rule processing. On the other hand, the flow table stored in the TCAM device can be configured to enable processing of packets that require mask match type or prefix match type based rule processing.

Aspects of the present disclosure can further relate to a system that includes an SDN controller, and a switch cluster having a plurality of switches, wherein the switch cluster can be operatively coupled with the SDN controller, and wherein at least one switch of the switch cluster can be configured to store a flow table in either a DRAM device or in a TCAM device based on a table match criteria associated with the particular table. The flow table can be stored in a DRAM device when the table match criteria requires exact match rules for performing exact matching. Alternatively, the flow table can be stored in a TCAM device when the table match criteria requires regular expression-based rules for performing regular expression based matching.

In an aspect, the present disclosure can further relate to a method for storing a flow table within an SDN switch involving the steps of receiving the flow table at the switch, and storing the flow table in either a DRAM device or in a TCAM device based on a table match criteria associated with the rules stored therein.

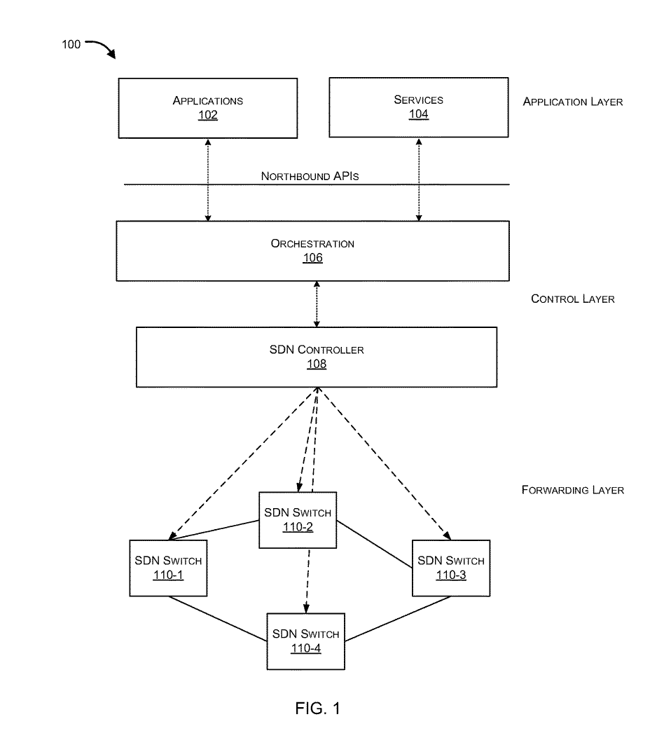

FIG. 1 illustrates an exemplary SDN architecture 100 in accordance with an embodiment of the present disclosure. SDN architecture 100 can be used for programming flexible data path pipelines to be used by SDN switches 110. As described above, SDN allows the abstraction of network functions in order to, among other things, control network security functions performed by SDN switches 110. SDN decouples the operating system functions that gather forwarding table information from forwarding hardware, and abstracts the functionality of legacy hardware into three layers such as an application layer, a control layer and a forwarding layer. The flexible pipeline SDN approach described herein provides many advantages over traditional monolithic flow processing pipelines. For example, the control plane applications that implement important network routing and switching functionalities are completely separated from the forwarding plane. Maintaining a centralized control plane enables highly customized and optimized networking services that can be tailored to specific user needs or specific network setup. A centralized control plane provides a highly scalable, reliable and flexible networking infrastructure that can cater to diverse user needs. Though embodiments of the present disclosure are described herein with reference to a centralized control plane, in different implementations, it is possible to have a localized control plane for configuring the SDN switches. In an exemplary implementation, SDN switches, such as SDN switch 110-1, SDN switch 110-2, SDN switch 110-2, and SDN switch 110-4, which may be collectively and interchangeably referred to as SDN switches 110 or as OpenFlow-enabled switches 110 hereinafter, can be programmed using the OpenFlow Protocol.

In an exemplary implementation, SDN switches 110 can be programmed to define how to match packets with appropriate security and/or forwarding rules and how to forward the packets based on the programmable rules. SDN switches 110 can be programmed to switch packets to/from network security devices (not shown). In a typical implementation, when a data packet is received from real time traffic, SDN switch 110 determines a pipeline to be used for forwarding the packet towards the destination. When SDN switches 110 observe an unknown flow and/or can't determine how to forward/process a particular packet, SDN switches 110 may consult SDN controller 108 to determine what to do with the flow, and then based on the configuration received from SDN controller 108, make an appropriate decision. In general, SDN switches 110 may include multiple tables for storing the rules upon which forwarding/processing decisions are made. In an exemplary implementation, the multiple tables used by SDN switches 110 are stored in TCAM or DRAM devices.

In an exemplary implementation, the application layer can include one or more applications 102, and one or more network services 104 that can be used to determine forwarding requirements. Further the control layer can convert the forwarding requirements/information into flow programmable statements by using orchestration engine 106. On receiving the forwarding requirements/information from the upper layer, SDN controller 108 operating within the control layer can configure the program flows into OpenFlow-enabled switches (e.g., SDN switches 110) using the OpenFlow Protocol. In an exemplary implementation, when the program flow information is received from upper layers, the controller 108 can categorize the program flows, also referred interchangeably as program flow statements, into different categories such as fixed/exact match type, regular expression type, among others, and can store the categorized program flows either in DRAM or TCAM. In an exemplary implementation of the present invention, the controller 108 using the OpenFlow Protocol can program the SDN switches 110 to store exact match based rules in DRAM and regular expression based rules in TCAM.

In an exemplary aspect, virtual BGP routing instances may run in the application layer by the applications 102 or by the services 104, and can dynamically modify programmed flows delivered to OpenFlow-enabled SDN switches 110 that can store the exact match based rules in the DRAM, and regular expression based rules in TCAM of the SDN switches 110.

In an exemplary implementation, using the flex Pipeline architecture 100 as shown in FIG. 1, flow tables can be provisioned either in DRAM or TCAM based on the match type property of the tables of the SDN switches 110. In an exemplary implementation, rules with “exact” match types or “all_or_exact” match type can, for instance, be provisioned in DRAM based tables, and rules with “mask” match type or “prefix” type, also referred as regular expression type hereinafter, can be provisioned in TCAM based tables. As one may appreciate, each SDN switch 110 can be associated with or have access to both DRAM as well as TCAM devices in order to store a plurality of flow tables containing rules of appropriates types in either of the devices based on the type of rules being stored in respective flow tables. By storing the regular expression based rules in the TCAM and exact match rules in the DRAM, the SDN switches 110 can meet required effective line-rate performance and provide improved line-rate performance.

In an exemplary implementation, SDN controller 108 and SDN switches 110 can be configured to use any open protocol, e.g., the OpenFlow Protocol, to program forwarding, processing and/or security instructions, known as flows, rules etc, onto the forwarding layer hardware or SDN switches 110. Management protocols, including, but not limited to the OpenStack suite or NETCONF, can be used to configure device management options of the forwarding layer hardware and/or SDN switches 110.

Flexible pipeline architecture 100 can be used to meet the performance requirements to inspect traffic on high-performance (e.g., 40 GB and 100 GB) links beyond Layer 4. Flexible pipeline architecture 100 can be configured to meet performance gate requirements of high speed network links while intelligently shunting traffic-of-interest to one or more network security devices for associated network security and meet aggregate network security and performance requirements.

In an exemplary implementation, SDN controller 108 can be configured to support flow programming and provide super flow-to-flow abstraction, and other future orchestration features. SDN controller 108 can provide an ability to parse a super flow into individual flows supported within the SDN appliances. In an exemplary implementation, orchestration engine 106 can be a part of SDN controller 108 or can be an independent network device. Though SDN controller 108 is described in various embodiments described herein as implementing the OpenFlow Protocol, the teachings herein are applicable in other contexts including prior and future versions of the OpenFlow Protocol and similar protocols.

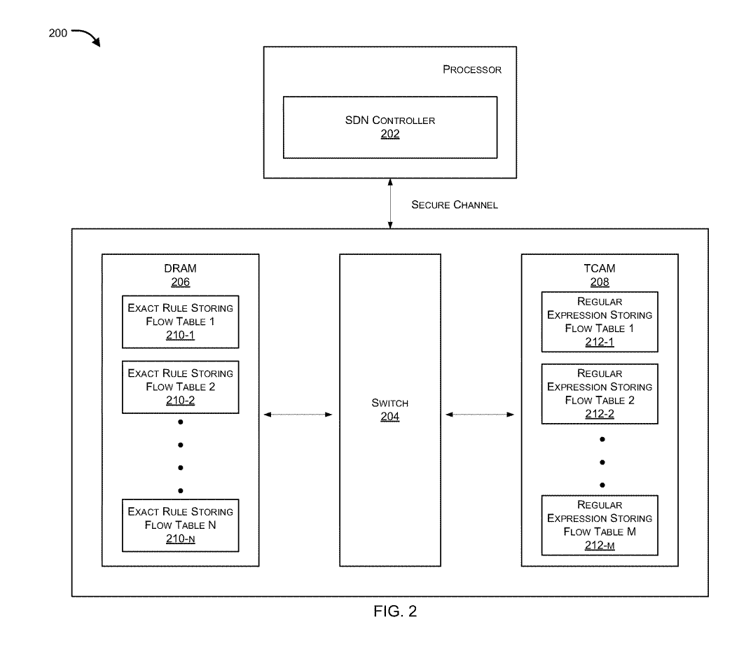

FIG. 2 illustrates a high-level overview of an exemplary SDN device architecture 200 in accordance with an embodiment of the present disclosure. In an exemplary implementation, SDN controller 202 can be configured to send configuration to SDN switch 204 using an appropriate protocol (e.g., the OpenFlow Protocol) and a secure channel. On receiving the configuration information via OpenFlow Protocol statements, for example, switch 204 can store the associated keys/rules within a memory deemed most suitable based on the types of rules at issue. For example, in the context of the present example, SDN switch 204 can be operatively coupled with or include a TCAM device 208 as well as a DRAM device 206 for storage of policy rules to be used for making forwarding and/or security decisions relating to received packets. Those of ordinary skill in the art will appreciate the flexible pipeline architecture described herein allows these rules to be configured/programmed by SDN controller 202 using appropriate protocols/standards, including, but not limited to the OpenFlow Protocol In an exemplary implementation, SDN switch 204 can be configured to store rules implementing exact match type keys in TCAM device 208, and rules implementing regular expression-based matching in DRAM device 206. Software networking functions and/or open networking protocols can be used for programmatically controlling hardware traffic flows. In an exemplary implementation, SDN controller 202 and switch 204 can be configured to provide a scalable/flexible data-center based network security and monitoring solution.

For providing efficiency and scalability in SDN switches 204, in an exemplary implementation, DRAM 206 can be configured to store rules of the exact match type in exact match storing tables such as exact rule storing flow table 1 210-1, exact rule storing flow table 2 210-2, . . . , and exact rule storing flow table 210-N, and TCAM 208 can be configured to store rules of the regular expression matching type in the regular expression storing tables such as regular expressing storing flow table 1 212-1, regular expressing storing flow table 2 212-2, . . . , and regular expressing storing flow table 212-M. As those of ordinary skill in the art will appreciate, DRAM device 206 can be configured to store multiple tables that can store programmable rules. In an aspect, resources of TCAM 206 and DRAM 208 can be logically divided into multiple flow tables that can respectively store regular expression keys/rules, and exact match keys/rules. Similarly, TCAM 208 can be logically divided to have multiple tables that can be configured to store programmable rules. Tables 210 stored within DRAM 206 can have exact match keys/rules, and tables 212 stored within TCAM 208 may have regular expression based keys/rules (e.g., subnet based matching or port range based matching rules). In an exemplary implementation, data path pipeline can be defined by SDN controller 202 and flows can be programmed into these tables.

In an exemplary implementation, the least expensive devices (silicon chips) that can be used to implement the lookup tables are DRAM based devices, but may not be efficient as they may waste memory when used for regular expression based keys. It has been observed through studies that the most efficient devices for processing SDN keys/rules are TCAM devices, but such devices are very expensive and use a lot of power. DRAM is more efficient in implementing/processing exact match-based rules. As regular expression-based rules require more space/resources, switch 204 can use TCAM 208, which can provide faster processing, and DRAM 206, which is less expensive, can be used for storing exact match keys/rules. In an exemplary implementation, by storing regular expression keys/rules in TCAM 208, and exact match keys/match in DRAM 206, overall power consumption of switch 204 can be reduced and average packet processing time by switch 204 can be improved. By storing exact match keys/rules in DRAM 206, and regular expression keys/rules in the TCAM 208, the capacity of the flow table tables can also be increased without adding much cost or greatly increasing power requirements of switch 204. The hybrid memory approach described herein also provides increased flexibility in defining different data-path pipelines with SDN/OpenFlow programmability.

In an exemplary use case, SDN architecture 200 can use the OpenFlow Table Type Patterns (TTP) specification to configure the flow table pipeline to be used by SDN switch 204, and for supporting a multi-table pipeline for data path. The life cycle of TTP and its support in SDN controller 202 and in switch 204 can be defined in the specification. In non-Flex Pipeline architectures, supporting a new TTP can involve one or more activities including new architecture, design changes, HW revision and SW development. However, Flex Pipeline architecture of the present disclosure can support new TTP, just by providing the TTP specification in appropriate format, for example JSON format, as specified in the TTP specification. In an exemplary implementation, flow tables can be provisioned in either

DRAM or TCAM based on the match type property of the table, using the TTP specification. In an exemplary implementation, keys/rules with “exact” match types or “all_or_exact” match type can be provisioned in DRAM 206 based tables 210, whereas rules/keys with match types “mask” or “prefix”, also referred to as regular expression type, can be provisioned in TCAM 208 based tables 212. The flex pipeline architecture of present disclosure provides significant flexibility to customers and fast time to market in supporting new TTPs.

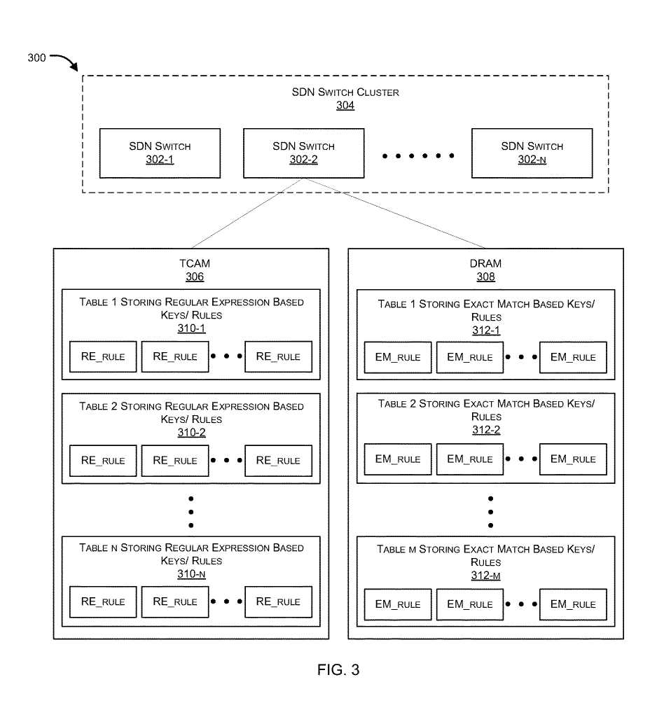

FIG. 3 illustrates an exemplary configuration and use of flow tables stored in TCAM and DRAM devices for performing flow control function in accordance with an embodiment of the present invention. As shown in FIG. 3, an SDN switch cluster 304 may include a plurality of SDN switches such as SDN switch 302-1, SDN switch 302-2, . . . , and SDN switch 302-N, collectively and interchangeably referred as SDN switch 302, which can be configured to implement flexible pipe-lines. Each of the SDN stitches 302 of the SDN switch cluster 304 can be connected to an SDN controller that can configure flexible pipes/rules for forwarding flow processing and/or forwarding a packet received from network. In an exemplary implementation, the SDN switch 302 can be configured to store flow tables in either a TCAM device 306 or in a DRAM device 308 based on a table match criteria, wherein the flow tables can be stored in a DRAM 308 if the table match criteria indicates that the flow table stores exact match rules for performing exact matching, and the flow tables can be stored in a TCAM 306 if the table match criteria indicates that the flow table stores regular expression based rules for performing regular expression based matching.

In an exemplary implementation, the TCAM 306 and DRAM 308 may have multiple tables that can store the rules related to flexible pipelines. In an aspect, TCAM 306 associated with SDN switch 302 can be configured to include a plurality of tables such as Table 1 storing regular expression based keys/rules 310-1, Table 2 storing regular expression based keys/rules 310-2, and table-N storing regular expression based keys/rules 310-N. Each of the tables of the TCAM 306 can store a plurality of regular expression rules, also referred as RF_rules. Similarly, DRAM 308 associated with the SDN switch 302 can be configured to store a plurality of tables for storing exact match based keys/rules. For example, DRAM 308 may have Table 1 storing exact match based keys/rules 312-1, Table 2 storing exact based keys/rules 312-2, and Table M storing exact match based keys/rules 312-M. Each of the tables 312 of the DRAM 308 can be configured to store a plurality of exact match rules, also referred as EM_rules. In an exemplary implementation, on receiving the configuration/specification files from the controller, the SDN switch 302 can configure the rules in appropriate device based on the types of rules. The SDN controller can update rules directly in the flow tables such as tables storing regular expression based keys/rules 310 and tables storing exact match based keys/rules 312 to control rules that are set up for each packet flow.

In an exemplary implementation, upon receiving a data packet from the network, the SDN switch 302 can refer/use the TCAM 306 if the forwarding rules are based on the regular expression based key matching, and can refer to DRAM 308 if the forwarding rules are based on exact match rules. The flow tables 312 stored in the DRAM 308 can be configured to enable processing of packets that require exact or all_or_exact based rule processing, and the flows table 306 stored in the TCAM 306 can be configured to enable processing of packets that require mask or prefix based rule processing or regular expression based processing.

In an exemplary implementation, definition of flow table such as table 312 stored in the DRAM 308, and table 310 stored in the TCAM 306 can be defined by SDN controller using appropriate protocol/specification file(s) and can include key compositions/rules based on plurality of relevant header fields of protocol headers. The flow tables can be created and keys/rules can be stored in these tables based on the configurable flow table definitions. Each of the flow tables such as table 312 and table 310 may include configurable key columns associated with relevant header fields identified by the key composition included in the flow table definition. Further the flow tables may also include a set of one or more action fields to store forwarding decisions to be taken by the SDN switches 302. In an exemplary implementation, the control can configure/install the logic to be used by the SDN switches 302 for selecting between flow tables stored in the TCAM 306 or DRAM 308. The SDN switches 302 can receive data/configuration files from the controller, and can populate the configurable key columns and action columns of the flow tables.

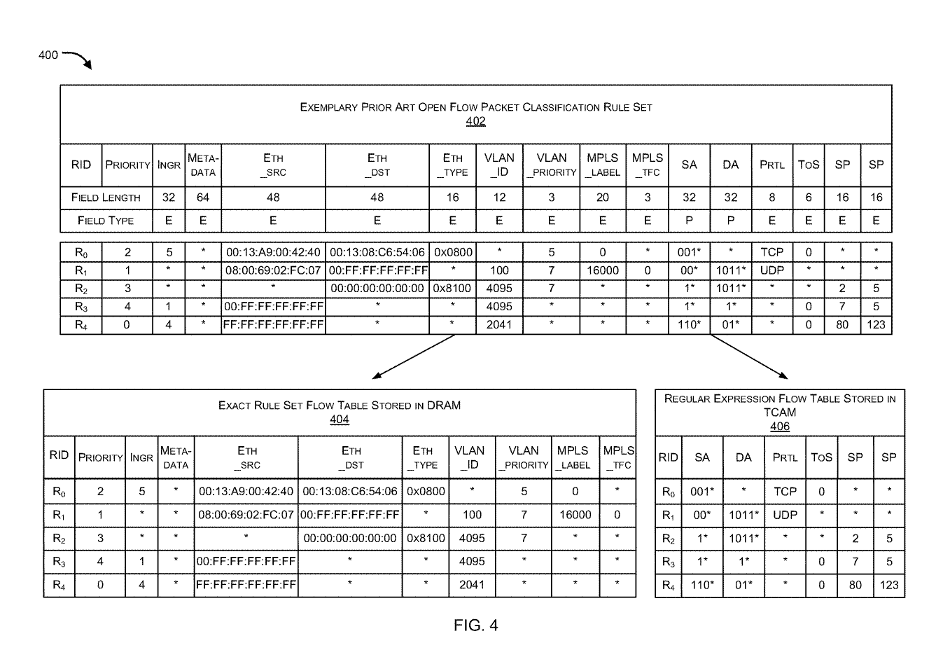

FIG. 4 illustrates exemplary split of a single lookup table into a first table stored in DRAM device, and a second table stored in TCAM device in accordance with an embodiment of the present invention. As illustrated, when a flow table such as 402 comprises both exact match based rules as well as regular expression based rules, the table can be split into two flow tables, one storing exact match rules, and the other storing regular expression based on rules. As can be seen, in table 402, fields Priority through MPLS_TFC store fixed rules, and fields SA through SP store regular expression based rules, and therefore a first flow table 404 can be created/generated based on exact match based rules and stored in DRAM device, and second flow table 406 can be created/generated based on regular expression based rules and stored in TCAM device.

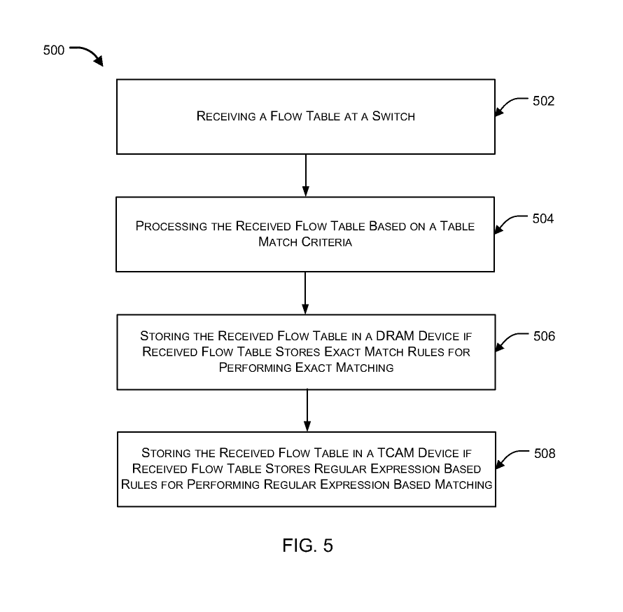

FIG. 5 illustrates an exemplary flow diagram 500 showing the use and configuration of flow tables stored in TCAM and DRAM devices in accordance with an embodiment of the present invention. As shown, at step 502, an SDN switch can receive a flow table and at step 504, the flow table can be stored within an appropriate memory device based on the manner in which one or more packet fields are to be matched against the rules within the flow table. At step 506, when the table match criteria involves performing exact matching-based rules, the flow table can be stored in a DRAM device, which is more efficient for this purpose; otherwise, at step 508, when the table match criteria involves performing regular expression-based matching rules, the flow table can be stored in a TCAM device, which operates more efficiently in such a context.

In an aspect of the present disclosure, as disclosed above, since the DRAM is efficient in implementing tables having exact match keys, such keys can be implemented in DRAM, wherein since the TCAM is efficient in implementing tables having regular expression based keys, such keys can be implemented in TCAM. Therefore, DRAM and TCAM resources can be logically divided into multiple flow tables, wherein the data-path pipeline can be defined by the SDN controller and flows can be programmed into these tables using DRAM for exact match tables and using TCAM for regular expression match tables. In this manner, increased flow table capacity is provided where required, and increased flexibility and efficiency is provided for regular expression-based tables. Embodiments of the present invention also increase flexibility in defining different data-path pipelines with SDN/OpenFlow programmability.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that variations other than those modifications and alternatives described herein are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A software-defined networking (SDN) switch comprising:
a Dynamic Random-Access Memory (DRAM) device;
a Ternary Content-Addressable Memory (TCAM) device;
a plurality of flow tables stored within the DRAM device and the TCAM device; and
wherein a first flow table of the plurality of flow tables is stored within the DRAM device as a result of the first flow table containing therein rules for which a first type of match criteria is performed against one or more fields of a packet received by the SDN switch in order to determine how to process the packet; and
wherein a second flow table of the plurality of flow tables is stored within the TCAM device as a result of the second flow table containing therein rules for which a second type of match criteria is performed against the one or more fields of the packet in order to determine how to process the packet.

2. The SDN switch of claim 1, wherein the switch forms part of a switch cluster that is operatively coupled with an SDN controller.

3. The SDN switch of claim 2, wherein the SDN controller causes the SDN switch to update the rules to control packet flows identified by the SDN controller.

4. The SDN switch of claim 1, wherein the first type of match criteria requires an exact match or an all_or_exact match between the one or more fields and one or more corresponding keys of the first flow table.

5. The SDN switch of claim 1, wherein the second type of match criteria requires regular expression-based matching between the one or more fields and one or more corresponding keys of the second flow table.

6. The switch of claim 5, wherein the regular expression-based matching supports mask match type or prefix match type based rule processing.

7. A system comprising:
an software-defined networking (SDN) controller; and
a switch cluster comprising a plurality of SDN switches operatively coupled with the SDN controller;
wherein at least one SDN switch of the switch cluster is configured to store a flow table in either a Dynamic Random-Access Memory (DRAM) device or in a Ternary Content-Addressable Memory (TCAM) device based on a match criteria used to determine a match between a particular rule within the flow table and a packet received by the SDN switch;
wherein the flow table is stored in the DRAM device when the match criteria requires an exact match; and
wherein the flow table is stored in the TCAM device when the match criteria requires a regular expression-based match.

8. The system of claim 7, wherein the exact match enables processing of packets that require exact or all_or_exact-based rule processing.

9. The system of claim 7, wherein the regular expression-based match enable processing of packets that require mask or prefix-based rule processing.

10. A method comprising:
receiving, by a software-defined networking (SDN) switch, a flow table for use in connection with determining how to process a packet received by the SDN switch;
storing, by the SDN switch, the flow table in a Dynamic Random-Access Memory (DRAM) device of the SDN switch when rules contained within the flow table comprise one or more keys against which exact matching is performed with one or more fields of the packet;
storing, by the SDN switch, the flow table in a Ternary Content-Addressable Memory (TCAM) device of the SDN switch when rules contained within the flow table comprise one or more keys against which regular expression-based matching is performed with the one or more fields of the packet.

11. The method of claim 10, wherein the SDN switch forms part of a switch cluster that is operatively coupled with an SDN controller.

12. The method of claim 11, further comprising updating, by the SDN controller, the rules contained within the flow table to control packet flows identified by the SDN controller.

13. The method of claim 10, wherein the exact matching enables processing of packets that require exact or all_or_exact based rule processing of the packet.

14. The method of claim 10, wherein the regular expression-based matching supports mask match type or prefix match type based rule processing of the packet.

15. The method of claim 10, wherein a result of the exact matching or the regular expression-based matching comprises a flow identifier or an address of a next node along a flow path for a flow with which the packet is associated.
